(19) United States
(12) Patent Application Publication
(10) Pub. No.: US 2011/0226712 A1
(43) Pub. Date: Sep. 22, 2011

(54) Storage rack system

(76) Inventor: Dan Morton, Buffalo Grove, IL (US)

(21) Appl. No.: 12/804,458

(22) Filed: Jul. 22, 2010

Related U.S. Application Data
(60) Provisional application No. 61/227,726, filed on Jul. 22, 2009.

(51) Int. Cl. A47G 29/00; F16M 13/00

(52) U.S. Cl. 211/64; 211/119.004

(57) ABSTRACT

An article for storing items along the inside of a door. One embodiment is a grid attached alongside the inside of the door with various structures designed to support items, specifically U brackets designed to hold handguns. Another embodiment is a small grid with structures designed like holsters, enabling a large number of handguns in a small area. Another embodiment uses a large grid with structures to support long guns. In all embodiments, structures may be attached to support other items. The embodiments may be attached to the inside of the door which is most commonly a safe door, by brackets or by other attachment assemblies.

### CROSS-REFERENCE TO RELATED APPLICATIONS

This application claims priority to the provisional patent application No. 61/227,726 for “Storage Rack System”, filed by the same inventor on Jul. 22, 2009, the disclosure of which is expressly incorporated herein by reference.

### BACKGROUND OF THE INVENTION

This invention relates to maximizing storage within an enclosure having a door such as a closet, locker, safe, or similar storage structure by utilizing an interior surface of the door. While it is known to attach various article holding devices to the inside of a door to gain additional storage, such storage “solutions” are typically fixed in position and interfere with usable interior space when the door is closed. Also, known solutions for creating storage space on the inside of a door fail to utilize much of the available surface area on the inside of the door, do not provide a user configurable storage arrangement nor do they provide features which utilize unused interior corner space on the inside of the door frame above or below the hinges.

In particular, safes are expensive and cost-prohibitive to upgrade when additional storage space is desired. However, the items an owner wishes to protect by storing in a safe will continue to grow. For example, over time a gun collector will typically purchase more guns and gun accessories. Additionally, other items, such as jewelry, important documents, and other difficult to replace items, will often be stored inside a safe. Therefore, a safe owner has a strong interest in maximizing the storage capabilities of any safe.

### SUMMARY OF THE INVENTION

This invention exploits the relatively close tolerances between a door and door frame to provide a discreet and unobtrusive anchor point for supporting a user configurable system that greatly expands the usable storage space inside of an enclosure such as a closet, locker, safe or similar storage structure. The same issues arise for vaults, which use similar doors on a larger scale.

The prior art in this area is cumbersome and inefficient. It is often difficult to install, requiring either great skill, a large amount of time, or both. The prior art often leaves open space which is not used in the actual storage.

### BRIEF DESCRIPTION OF THE DRAWINGS

Embodiment examples of the invention are illustrated in the set of drawings and will be specified in greater detail in what follows.

FIG. 1 is a perspective view of a first preferred embodiment of the present invention;

FIG. 2 is a perspective view of a second preferred embodiment of the present invention;

FIG. 3 is a perspective view of a third preferred embodiment of the present invention;

FIG. 4 is a perspective view of a fourth preferred embodiment of the present invention.

### DESCRIPTION OF THE PREFERRED EMBODIMENTS

The invention is constructed of sheet metal, wire, plastic, carbon fibers, or any other substantially rigid material. At the top is a means for anchoring the invention to a door. One example is a 90 degree bend in the material, creating an upside down “L” shaped bracket (10). The top of the bracket (10) may have pre-inserted methods for securing to the top of a door. One or more of these brackets (10) may be secured to the top of the door for supporting various storage devices along the inside surface of the door. Along a vertical leg of the bracket (10), one or a number of storage devices may be attached. The bracket can be attached to the door by another bracket, tab, slot, hook, loop, screw, nut, bolt, glue, weld, adhesive, Velcro, or other appropriate method.

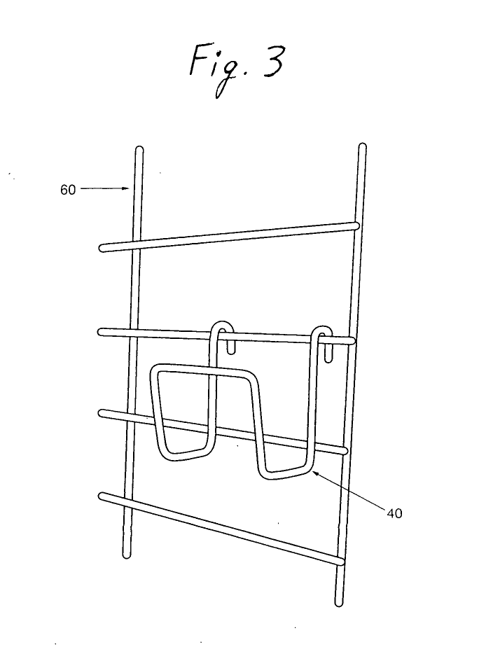

In one embodiment numerous storage receptacles or “holsters” (20) are suspended from or connected between the brackets (10). These holsters (20) are created with two horizontal rack members (30) attached to vertical members which are attached to the bracket (10) such that they extend horizontally along an inside surface of the door; one member at the bottom with the other above. The two horizontal rack members (30) each have openings which vertically align to form a plurality of storage receptacles. This allows a plurality of items, specifically handguns, to be stored vertically in a relatively small area near the top of the door. The two horizontal rack members (30) may comprise two separate components attached to the brackets or a unitary component which is formed into an approximate “U” shape (40); the bottom of the “U” (40) being secured to the vertical leg of the bracket or brackets (10) such that the “U” is oriented horizontally. This embodiment is shown in FIG. 3. The two horizontal rack members (30) and one or more “L” brackets (10) may also comprise a single integrated or unitary structure. Additionally, another device may be attached to or suspended from the bottom member, creating another layer or level of storage locations.

The “U” shapes serve to supply support for items stored on the invention. Alternative means of support may be used; such as hooks, elastic, static cups, adjustable cups, rotating cups, or the equivalent. These means of support may be used individually or in combination, for example cups and hooks may be used to support long guns. The cups may rotate to support the base of the long gun while the barrel is supported by another mean disclosed above. The rotating cups will also allow a plurality of long guns to be stored along the interior of a safe door and allow the safe door to properly close. Storing the long guns along the door allows the interior space of the safe to be used for alternative storage, while giving greater access to the long guns.

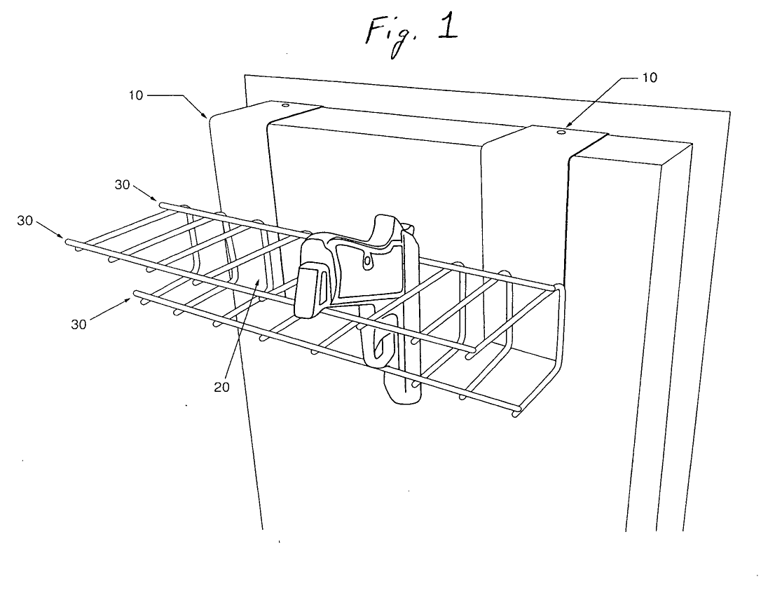

Another embodiment provides “holsters” in the form of one or more brackets (10) attached to the top of the door and suspending horizontal receptacle members (20) which extend beyond an inside edge of the door on the hinge side. This embodiment is shown in FIG. 1. This extended portion will rotate or “turn in” to an area behind the inside of the door frame on the hinge side of the frame when the door is closed. This configuration enables unused space immediately behind the door frame on the hinge side of the frame to be utilized for additional storage of items, specifically handguns. The horizontal receptacle members allow the handguns to be stored vertically, side-by-side with the muzzles pointing down. This is an efficient and safe use of typically wasted space.

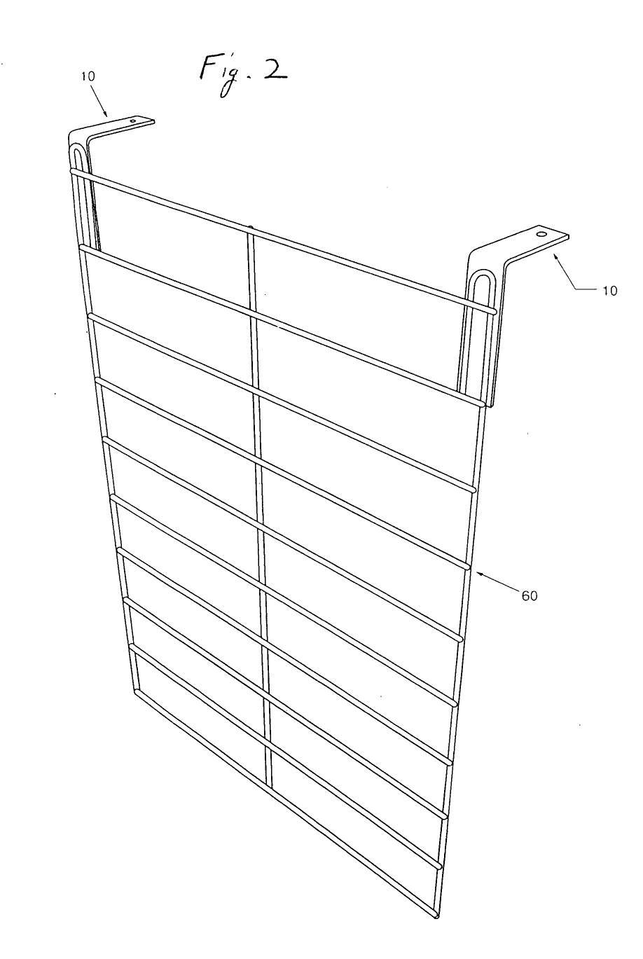

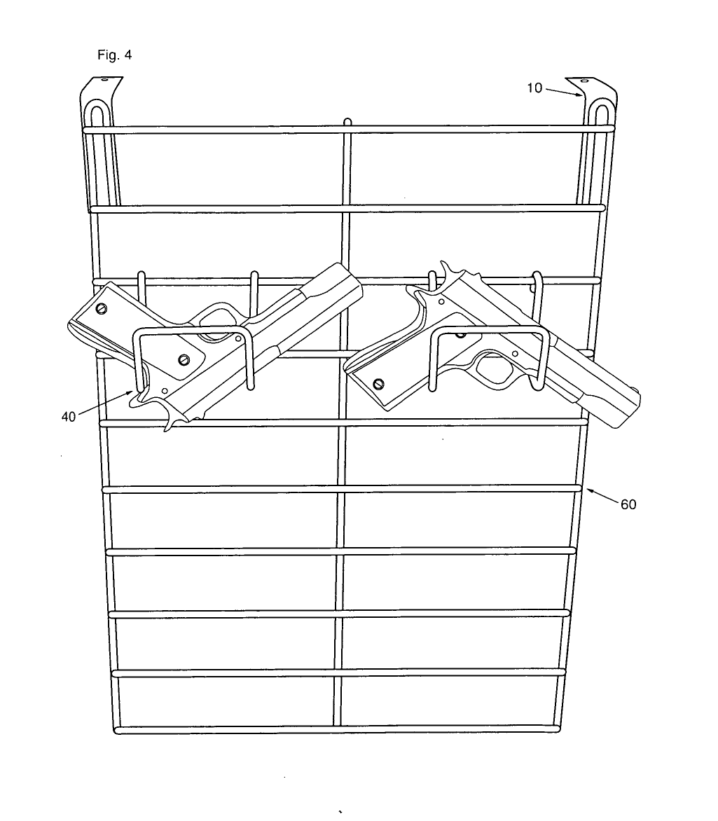

Another embodiment provides a backing structure or grid on the inside of the door. This embodiment is shown in FIG. 2. Again, one or more brackets (10) are secured to the top of the door. A grid of relatively rigid material (60) such as wire, metal, plastic or other relatively rigid material, including any perforated sheet material, is attached to the brackets. To this grid, various attachments can be secured, including hooks, brackets, document holders, pouches, storage receptacles, pistol holders, rifle holders or other means for securing objects to the grid. The embodiment with attachments is shown in FIG. 4. This allows the user to utilize the entire inside of the door. The grid will not obstruct any shelves or partitions contained within the safe. All or portions of the grid can be covered with wires, pegboards, or slat-wall. The user will be able to configure the grid to fit his specific needs.

The brackets which support the storage system can be secured to the top ledge of a door through various means, including double sided tape, adhesive, magnets, hook and loop fasteners or a simple screw. This will allow the door to still function while previously wasted space is utilized. This is a simple and quick process. Many of the securing methods require no special tools and can be accomplished by a user in minimal time, often under ten minutes.

The system allows the user to maximize the storage space in an existing space, while maintaining the security. Furthermore, it makes accessing the items contained in a closet, locker, safe, or similar storage structure easier and safer. The system protects the items by allowing each item to be stored in a secure manner, untouched by other items, minimizing scratching, dents, or other defects from contact with other items.

What is claimed is:

1-20. (canceled)

21. An article for storage inside a door comprising:
a. a plurality of brackets,
b. a grid of horizontal and vertical members attached to said brackets in a vertical manner,
c. means for attaching items to said grid for the purpose of securing articles.

22. The article for storage of claim 21 wherein the brackets are “L” brackets.

23. The article for storage of claim 21 wherein structures attached to the grid are U-shaped members.

24. The article for storage of claim 21 wherein the grid includes an end portion extending beyond the interior edge of the door such that some portion of the grid pivots or turns in to the interior region of the door when said door is closed.

25. The article for storage of claim 21 wherein a plurality of article are attached to the bottom of the first article to extend the storage area.

26. The article for storage of claim 21 wherein the structures attached to the articles are orientated in a vertical manner for suspending articles in a vertical manner.

27. The article for storage of claim 21 wherein the structures attached to the articles are orientated in a horizontal manner for suspending articles in a horizontal manner.

28. The article of storage of claim 21 wherein the structures attached to the grid are hooks.

29. The article of storage of claim 21 wherein the structures attached the grid are capable of storing the barrel of a long gun on one end and the butt of said gun on the other end.

30. The article for storage of claim 21 wherein the article is made of a material elected from the group consisting of metal, plastic, and carbon fiber.

31. The article for storage of claim 21 wherein the door is a safe door.

32. The article for storage of claim 21 wherein the means for attaching items to the grid are spaces between the horizontal members which holster guns in a vertical, side by side manner with the guns' butts perpendicular to the door and pointing away from the door.

33. An article for storage inside a door comprising:
a. a grid of horizontal and vertical members attached to said brackets in a vertical manner,
b. the means for attaching said grid to said door,
c. the means for securing items to the grid.

34. The article for storage of claim 33 wherein the means for attaching said grid to said door is “L” brackets.

35. The article for storage of claim 33 wherein the article is made of a material elected from the group consisting of metal, plastic, and carbon fiber.

36. The article for storage of claim 33 wherein the door is a safe door.

37. An article for storage inside a door comprising:
a. a plurality of brackets,
b. two horizontal members attached to said brackets by vertical members,
c. a series of “J” shaped members attached to said horizontal members for the purpose of storing handguns.

38. The article for storage of claim 37 wherein the article is made of a material elected from the group consisting of metal, plastic, and carbon fiber.
